(19) United States
(12) Patent Application Publication
(10) Pub. No.: US 2014/0183224 A1
(43) Pub. Date: Jul. 3, 2014

(54) TOOTHPASTE TYPE FERTILIZER

(71) Applicant: Guangdong Dazhong Agriculture Science Co., Ltd., Dongguan City (CN)

(72) Inventor: Xiaoming LIN, Dongguan City (CN)

(73) Assignee: Guangdong Dazhong Agriculture Science Co., Ltd., Dongguan City (CN)

(21) Appl. No.: 14/101,772

(22) Filed: Dec. 10, 2013

(30) Foreign Application Priority Data
Dec. 29, 2012 (CN) 201210588078.0

(51) Int. Cl. A01C 15/02; B65B 3/04

(52) U.S. Cl. CPC A01C 15/02; B65B 3/04
USPC 222/107; 222/92; 53/428

(57) ABSTRACT

A toothpaste type fertilizer, which includes a toothpaste casing and paste fertilizer contained in the toothpaste casing. The toothpaste type fertilizer breaks a traditional fertilizer split charging mode, and the fertilizer is contained in the toothpaste casing to enable a package of the fertilizer to tend to miniaturization and facilitation, which avoids troublesome caused by buying large-package fertilizer and brings conveniences for to a plant culturist in an urban family; when in use, squeezing out the fertilizer in a needed amount like squeezing toothpaste is only required; after completion of use, the fertilizer is easy to save and store, and no taste of the fertilizer is spilled out. The toothpaste type fertilizer can serve as a fast-moving consumer goods appeared in various shopping malls and supermarkets, and can further serve as a gift for presenting relatives and friends.

### FIELD OF THE INVENTION

The present invention belongs to the technical field of fertilizer, and relates to toothpaste type fertilizer in particular.

### BACKGROUND OF THE INVENTION

Fertilizer is a kind of substances that offer one or more than one nutrition element that is necessary for plants, improves the soil property and improves the soil fertility level, and is one of the material bases for agricultural production. At present, many plant enthusiasts in urban families may culture some plants such as flowers and vegetables in balcony or indoors. To supply the plants with nutrition elements, fertilizer is used necessarily.

The fertilizer on the market at present includes bagged fertilizer and bottled liquid fertilizer. Both packages of the bagged fertilizer and the bottled liquid fertilizer are large packages. Even if a buyer such as the enthusiast in the urban family requires a few amount of fertilizer, the buyer still needs to purchase large-package fertilizer at one time. The large-package fertilizer causes inconvenience to a user and also causes resource waste at the same time. Moreover, the residual fertilizer is difficult to save and store, and taste of the fertilizer will spill out to affect the living environment.

In addition, the existing bagged fertilizer and the existing bottled liquid fertilizer cannot appear on goods shelves of various shopping malls and supermarkets, and cannot server as fast-moving consumer goods since the weight and size caused by the large package limit sales and popularization of the fertilizer.

### SUMMARY OF THE INVENTION

The present invention aims at overcoming the defects of the prior art, and provides a toothpaste type fertilizer whose package tends to miniaturization and facilitation. The toothpaste type fertilizer is convenient to use, is easy to save and store, and serves as fast-moving consumer goods.

In order to realize the above target, the technical proposal of the present invention is as follows:

A toothpaste type fertilizer, the toothpaste type fertilizer comprises a toothpaste casing and paste fertilizer contained in the toothpaste casing.

Preferably, the toothpaste casing is a soft toothpaste casing.

Preferably, the toothpaste casing is a plastic toothpaste casing or an aluminum plastic toothpaste casing.

Preferably, the surface of the toothpaste casing is provided with a pattern layer.

Preferably, the toothpaste type fertilizer further comprises a cover body; the cover body is divided into a front end containing space and a back end connecting area through a mesh separation blade; the inside of the front end containing space is provided with water retaining agent, and the back end connecting area is connected to the toothpaste casing.

Preferably, the back end of the toothpaste casing is provided with a tearing part.

The preparation method for toothpaste type fertilizer, fertilizer is mixed into paste firstly to obtain paste fertilizer, and then the paste fertilizer is contained in a toothpaste casing.

Preferably, the detailed preparation steps of the toothpaste type fertilizer are as follows: counted by weight, adding 140-200 portions of water into 10-20 portions of biomass coke powder, 80-100 portions of potassium fulvic acid, 200-650 portions of nitrate, 100-460 portions of monoammonium phosphate, 60-90 portions of urea, 5-10 portions of seaweed meal, 0.2-1 portion of polyacrylamide, 2-5 portions of calcium sulfate, 1.5-3 portions of manganese sulfate, 0.5-1.5 portions of ferrous sulfate, 0.5-2 portions of zinc sulfate, 0.8-1.5 portions of copper sulfate and 0.5-1.5 portions of ammonium molybdate to mix into paste to obtain paste fertilizer.

Preferably, the grain size of the biomass coke powder is 10-100 μm.

Compared with the prior art, the invention has the advantages that: The present invention belongs to the technical field of fertilizer, and relates to toothpaste type fertilizer particularly, which includes a toothpaste casing and paste fertilizer contained in the toothpaste casing. The toothpaste type fertilizer breaks a traditional fertilizer split charging mode, and the fertilizer is contained in the toothpaste casing to enable a package of the fertilizer to tend to miniaturization and facilitation, which avoids troublesome caused by buying large-package fertilizer and brings conveniences for to a plant culturist in an urban family; when in use, squeezing out the fertilizer in a needed amount like squeezing toothpaste is only required; after completion of use, the fertilizer is easy to save and store, and no taste of the fertilizer is spilled out. The toothpaste type fertilizer can serve as a fast-moving consumer goods with large business value and appeared in various shopping malls and supermarkets, and can further serve as a gift for presenting relatives and friends.

### BRIEF DESCRIPTION OF THE DRAWINGS

FIG. 1 is a structure diagram of the present invention.

### DETAILED DESCRIPTIONS OF THE PREFERRED EMBODIMENTS

To be convenient for a person skilled in the art to understand, the following further introduces the present invention in details with reference to the embodiments. However, the protection scope of the present invention is not limited to the embodiments below.

### Embodiment 1

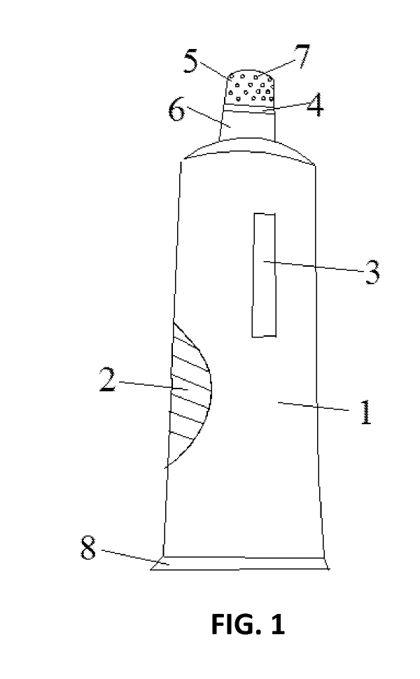

Referring to FIG. 1, toothpaste type fertilizer includes a toothpaste casing 1 and paste fertilizer 2 contained in the toothpaste casing 1. Of course, the fertilizer is not surely limited to paste, and may also be liquid or grain. The toothpaste casing 1 is a traditional toothpaste containing casing, and the size of the toothpaste casing 1 may be set as required. The toothpaste type fertilizer breaks a traditional fertilizer split charging mode, and the fertilizer is contained in the toothpaste casing 1 to enable a package of the fertilizer to tend to miniaturization and facilitation, which avoids troublesome caused by buying large-package fertilizer and brings conveniences for to a plant culturist in an urban family; when in use, squeezing out the fertilizer in a needed amount like squeezing toothpaste is only required; after completion of use, the fertilizer is easy to save and store, and no taste of the fertilizer is spilled out. The toothpaste type fertilizer can serve as a fast-moving consumer goods appeared in various shopping malls and supermarkets, and can further serve as a gift for presenting relatives and friends.

The toothpaste casing 1 is a plastic toothpaste casing 1. In particular, the toothpaste casing 1 is a plastic toothpaste casing or an aluminum plastic toothpaste casing, which is convenient to squeeze out the paste fertilizer 2.

The surface of the toothpaste casing 1 is provided with a pattern layer 3. The pattern layer 3 may be printed with an identity playing a role of propagandizing such as a trademark or propagandizing characters, and the like.

The toothpaste type fertilizer further includes a cover body. The cover body is divided into a front end containing space 5 and a back end connecting area 6 through a mesh separation blade 4. The inside of the front end containing space 5 is provided with water retaining agent. The back end connecting area 6 is connected to the toothpaste casing 1. When the package of the toothpaste type fertilizer is torn, the water retaining agent of the front end containing space 5 may be fully absorbed with water, so as to supplement water to the paste fertilizer 2 to prevent the paste fertilizer 2 from being dry and caking. To be specific, the back end connecting area 6 and the toothpaste casing 1 are connected in a threaded way. After completion of use, the back end connecting area 6 and the toothpaste casing 1 are connected to prevent the water in the paste fertilizer 2 from volatilization.

The back end of the toothpaste casing 1 is provided with a tearing part 8. When the paste fertilizer 2 is almost used up, the paste fertilizer 2 is difficult to be squeezed out from the front end of the toothpaste casing 1. At this moment, the back end of the toothpaste casing 1 may be torn from the tearing part 8, and the paste fertilizer 2 may be squeezed out from the back end of the toothpaste casing 1.

A preparation method for a toothpaste type fertilizer includes the step as follows: fertilizer is mixed into paste firstly to obtain paste fertilizer 2, and then the paste fertilizer 2 is contained in a toothpaste casing 1.

The detailed preparation steps of the toothpaste type fertilizer 2 are as follows: counted by weight, adding 140 portions of water into 10 portions of biomass coke powder, 80 portions of potassium fulvic acid, 200 portions of nitrate, 100 portions of monoammonium phosphate, 60 portions of urea, 5 portions of seaweed meal, 0.2 portion of polyacrylamide, 2 portions of calcium sulfate, 1.5 portions of manganese sulfate, 0.5 portions of ferrous sulfate, 0.5 portions of zinc sulfate, 0.8 portions of copper sulfate and 0.5 portions of ammonium molybdate to mix into paste to obtain paste fertilizer 2. The fertilizer efficiency of the paste fertilizer 2 prepared through the preparation method above is as long as 3 months. Flowers cultured by the fertilizer are arboreous.

The grain size of the biomass coke powder is 10 μm. The inside of the biomass coke includes a plurality of ducts, which not only may play a role of retaining water, but also is beneficial for slowly releasing the fertilizer efficiency. The above effect of the grain size of the biomass coke powder of the grain size is better.

### Embodiment 2

The difference between this embodiment and embodiment 1 is as follows: The detailed preparation steps of the toothpaste type fertilizer 2 are as follows: counted by weight, adding 180 portions of water into 15 portions of biomass coke powder, 90 portions of potassium fulvic acid, 450 portions of nitrate, 350 portions of monoammonium phosphate, 75 portions of urea, 8 portions of seaweed meal, 0.7 portion of polyacrylamide, 4 portions of calcium sulfate, 2 portions of manganese sulfate, 1 portions of ferrous sulfate, 1.5 portions of zinc sulfate, 1.2 portions of copper sulfate and 1.2 portions of ammonium molybdate to mix into paste to obtain paste fertilizer 2. The fertilizer efficiency of the paste fertilizer 2 prepared through the preparation method above is as long as 4 months. Flowers cultured by the fertilizer are arboreous.

The grain size of the biomass coke powder is 70 μm. The inside of the biomass coke includes a plurality of ducts, which not only may play a role of retaining water, but also is beneficial for slowly releasing the fertilizer efficiency. The above effect of the grain size of the biomass coke powder of the grain size is better.

### Embodiment 3

The difference between this embodiment and embodiment 1 is as follows: The detailed preparation steps of the toothpaste type fertilizer 2 are as follows: counted by weight, adding 200 portions of water into 20 portions of biomass coke powder, 100 portions of potassium fulvic acid, 650 portions of nitrate, 460 portions of monoammonium phosphate, 90 portions of urea, 10 portions of seaweed meal, 1 portion of polyacrylamide, 5 portions of calcium sulfate, 3 portions of manganese sulfate, 1.5 portions of ferrous sulfate, 2 portions of zinc sulfate, 1.5 portions of copper sulfate and 1.5 portions of ammonium molybdate to mix into paste to obtain paste fertilizer 2. The fertilizer efficiency of the paste fertilizer 2 prepared through the preparation method above is as long as 4 months. Flowers cultured by the fertilizer are arboreous.

The grain size of the biomass coke powder is 100 μm. The inside of the biomass coke includes a plurality of ducts, which not only may play a role of retaining water, but also is beneficial for slowly releasing the fertilizer efficiency. The above effect of the grain size of the biomass coke powder of the grain size is better.

The foregoing descriptions are merely preferred embodiments of the present invention, but are not intended to limit the embodiments of the present invention. Therefore, equivalent variation made according to the patent application scope of the present invention shall fall within the protection scope of the present invention.

What is claimed is:

1. A toothpaste type fertilizer, wherein the toothpaste type fertilizer comprises a toothpaste casing and paste fertilizer contained in the toothpaste casing.

2. The toothpaste type fertilizer according to claim 1, wherein the toothpaste casing is a soft toothpaste casing.

3. The toothpaste type fertilizer according to claim 1, wherein the toothpaste casing is a plastic toothpaste casing or an aluminum plastic toothpaste casing.

4. The toothpaste type fertilizer according to claim 1, wherein the surface of the toothpaste casing is provided with a pattern layer.

5. The toothpaste type fertilizer according to claim 1, wherein the toothpaste type fertilizer further comprises a cover body; the cover body is divided into a front end containing space and a back end connecting area through a mesh separation blade; the inside of the front end containing space is provided with water retaining agent, and the back end connecting area is connected to the toothpaste casing.

6. The toothpaste type fertilizer according to claim 1, wherein the back end of the toothpaste casing is provided with a tearing part.

7. A preparation method for a toothpaste type fertilizer according to claim 1, wherein fertilizer is mixed into paste firstly to obtain paste fertilizer, and then the paste fertilizer is contained in a toothpaste casing.

8. The preparation method for a toothpaste type fertilizer according to claim 7, wherein detailed preparation steps of the toothpaste type fertilizer are as follows: counted by weight, adding 140-200 portions of water into 10-20 portions of biomass coke powder, 80-100 portions of potassium fulvic acid, 200-650 portions of nitrate, 100-460 portions of monoammonium phosphate, 60-90 portions of urea, 5-10 portions of seaweed meal, 0.2-1 portion of polyacrylamide, 2-5 portions of calcium sulfate, 1.5-3 portions of manganese sulfate, 0.5-1.5 portions of ferrous sulfate, 0.5-2 portions of zinc sulfate, 0.8-1.5 portions of copper sulfate and 0.5-1.5 portions of ammonium molybdate to mix into paste to obtain paste fertilizer.

9. The reparation method for a toothpaste type fertilizer according to claim 8, wherein the grain size of the biomass coke powder is 10-100 μm.
